(19) United States
(12) Patent Application Publication
(10) Pub. No.: US 2012/0150738 A1
(43) Pub. Date: Jun. 14, 2012

(54) SYSTEMS AND METHODS FOR AUTOMATED PREFUNDING OF COMMERCIAL PAYMENTS

(75) Inventors: Allen O. Cage, Chantilly, VA (US); Steve A. Carlson, Manassas, VA (US); Kevin Woods, Manassas, VA (US)

(73) Assignee: AOC SOLUTIONS, INC., Chantilly, VA (US)

(21) Appl. No.: 13/316,214

(22) Filed: Dec. 9, 2011

Related U.S. Application Data
(60) Provisional application No. 61/422,062, filed on Dec. 10, 2010.

(51) Int. Cl. G06Q 20/14; G06Q 20/40

(52) U.S. Cl. 705/40

(57) ABSTRACT

Methods and systems for prefunded accounts are disclosed, which feature controlled credit limits on cards at the time of prefunding validation, creation of files that are electronically passed to a funding source, and implementation of a single use account. Various types of funding mechanisms can be utilized, including, ACH, wire transfer, or traditional check-based systems. According to the invention, an invoice that names a buying organization can be received by an entity offering prefunded account solutions. This can result in payment instructions being generated and funds being transferred from the organization to a funding entity. Once approval of a payment is received, a funded account can be created by transferring funding information by the solutions provider on behalf of the funding entity to a payment facilitator. When the seller generates account charge instructions, funds can be transferred from the payment facilitator to the seller.

### FIELD

The present invention relates generally to payment systems, and more specifically to the use of various funding mechanisms to allow prefunding of account in order to pay invoices.

### BACKGROUND

For many years, companies have been able to secure credit through various mechanisms, including loans and commercial credit card programs. As a result of various conditions (including down turns in the overall global economy or the desire by certain institutions to conduct business outside of their financial or geographical footprint), financial institutions have experienced difficulties in approving credit for some companies. Further, some companies may not have wanted to pay for more expensive financial processes (e.g., payment by check).

In addition, there are no card management and, more generally, no AP (Accounts Payable) payment tools in the market place that support the management, processing, and payment of this type of solution—that is consolidating it with the traditional card and AP payment functions.

Additionally, many companies may not want to “collateralize” loans or show any debt on their balance sheet due to the negative connotation this can have in many sectors of the markets (e.g., private corporations, universities, governments, and other similar entities). As a result, a process by which companies could avoid such difficulties and still achieve financing is needed.

### SUMMARY

The present invention can address specific needs that exist in the commercial payments industry. The commercial card payments industry comprises those stakeholders whose business model depends on any payment product used by organizations for the purpose of making payments for various goods and services.

In an embodiment of the invention, inherent risks can be removed that are associated with providing credit and helping to resolve debt issues by allowing entities to “pre-fund” their purchases. This can reduce or eliminate the need for entities to take on any additional debt normally associated with a commercial card program (i.e., nothing will appear on the balance sheet) and also allows financial issuers to expand their ability to provide financial incentives to end clients at a higher rate to win more business. Existing advanced commercial card technology cannot achieve these same outcomes. The opportunity revolves around using the same advanced card management, reporting, control and seamless integration found in online web solutions today (including, by way of example and not limitation, the EnCompass product, produced by AOC Solutions, Inc. of Chantilly, Va.) while tying that to a payment funded process in advance, carrying zero risk yet generating revenue shares to buyers geared towards driving increased adoption.

The use of a system according to the present invention employs controlling credit limits on cards at the time of prefunding validation, creation of files electronically passed to the originating funding source, introduction of a true single use account as well as an electronic notification and account number provision to qualifying and participating program vendors. Further, in a system according to the present invention, various types of funding mechanisms can be utilized, including, without limitation, automated clearing house (ACH), wire transfer, or traditional check-based systems. As is known in the industry, the ACH system comprises an electronic network used to process funding transactions in batches, including a full range of deposit transactions (e.g., direct deposit) and debit transactions (e.g., consumer bill payments). Other types of electronic payment networks have similar features. In contrast, wire transfer involves electronic transfer of funds directly between one entity and another.

One or more embodiments of the invention, may include or provide:
Electronic pre-funding capabilities
Automated clearing house (ACH) or wire-based funding—empowering a “Pre-Fund” solution (payment funded in advance, as discussed below in further detail)
New administrative user interface console (vendor portal to manage ACH payments (funding requests)
“Card Processor Funding File” to fund the SUGA (single use ghost account) on credit cards residing on the payment facilitator's system
Merchant notification process (e.g., electronic mail (“email”) message, fax, or both) allowing merchant to obtain card payment information, secure PCI (Payment Card Industry) compliant solution (where PCI includes the well understood PCI Data Security Standard)
Additional CSC (card security code) value added to card payment review process, which is configurable.
Additional level of card data access for financial institutions wanting to require entry of PIN (Personal Identification Number) to obtain card payment card information
Merchant log auto reconciliation process
“Unused Funds” reversal process using “Card Processor Funding File”
Financial institution setting configurations to support this solution
Organization setting configurations to support this solution
Market setting configurations to support this solution

### BRIEF DESCRIPTION OF THE DRAWINGS

FIG. 1 depicts an entity relationship diagram, according to an embodiment of the current invention;

FIG. 2 depicts a flow chart that details an exemplary commercial card prefunding process achieved via automated ACH, according to an embodiment of the current invention;

FIG. 3 depicts a system for automated prefunding, according to an embodiment of the current invention;

FIG. 4 depicts a screen shot of an administrative website page displayed by a service provider, according to an embodiment of the current invention;

FIG. 5 depicts a screen shot of a website page, according to an embodiment of the current invention;

FIG. 6 depicts a screen shot of a website page that displays the account information, according to an embodiment of the current invention;

FIG. 7 depicts a screen shot of a expiration page, according to an embodiment of the current invention;

FIG. 8 depicts a screen shot of a log search page, according to an embodiment of the current invention;

FIGS. 9 and 10 depict screen shots of a merchant log's account information page, according to an embodiment of the current invention; and

FIG. 11 depicts a screen shot of an inventory management page, according to an embodiment of the current invention.

### DETAILED DESCRIPTION

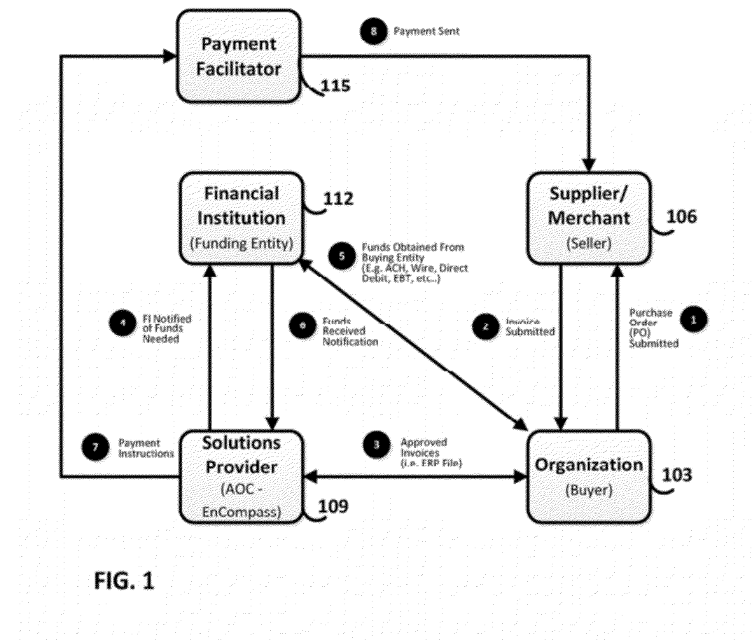

FIG. 1 depicts an entity relationship diagram of one embodiment of the present invention in which organization 103 (also known as a buyer) can submit purchase orders in a step 1 to supplier/merchant 106 (each supplier/merchant also known as a seller). Supplier/merchant 106 can process the purchase orders and an invoice naming the organization can be created and sent back to the organization, as shown in a step 2. Organization 103 can process invoices and send the invoices that have been approved for payment to a solutions provider 109 to pay the invoice based on the merchant 106 that was set up on the system of solutions provider 109 (shown in a step 3). When a supplier/merchant 106 is set up for a prefunded solution (i.e., an approach where funds are provided in advance of an actual invoice that is being paid), a financial institution 112 (or bank or any other similar funding entity) can be notified by solution provider 109 that funds need to be secured (shown in a step 4). Financial institution 112 can obtain the funds from organization/buyer 103 as shown in a step 5. Upon receipt of the funds, financial institution 112 can notify solutions provider 109 that the funds have been received and to authorize payment settlement back to supplier/merchant 106 (as shown in a step 6). Based on the payment method, payment instructions can be sent to payment facilitator 115 (shown in a step 7), where a payment facilitator can be any entity that provides the funds to the merchant, including, without limitation, a credit payment facilitator, a check processor, a wire processor, an ACH processor, or any other similar type of entity. Payment directions can include any type of message or indicator of the type of payment mechanism to be used and how such payment mechanism can provide payment. Payment facilitator 115 can then provide the payment to supplier/merchant 106. In an alternative embodiment, the functions of solutions provider 109 can be performed by financial institution 112.

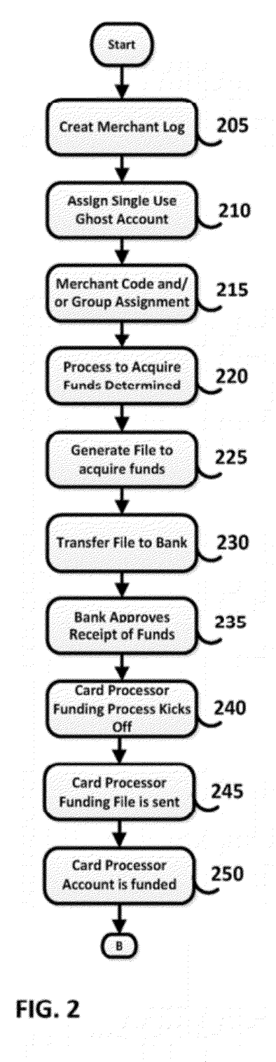

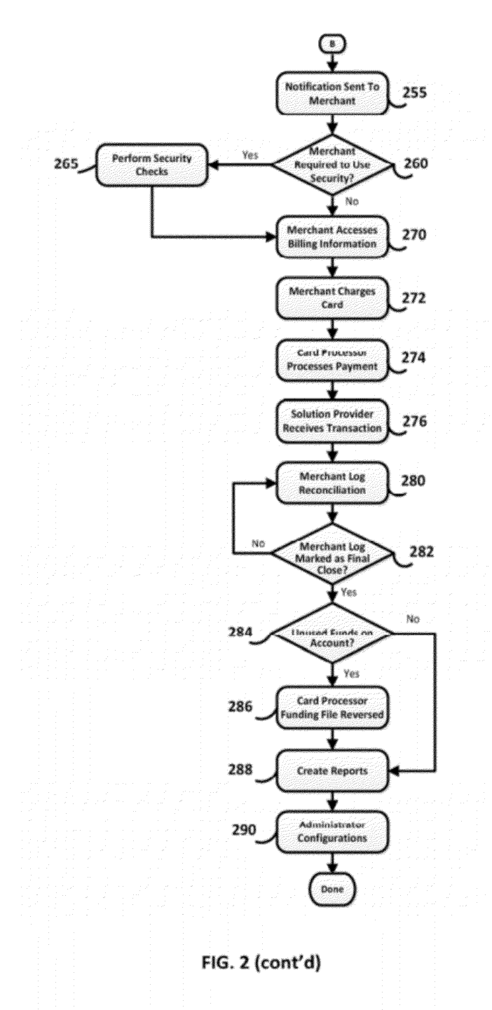

FIG. 2 depicts a flow chart that details an exemplary commercial card prefunding process achieved via automated ACH according to an embodiment of the current invention. As shown in a step 205, a merchant log can be created within a web based card management solution. In an embodiment, a merchant log can be a “record” created whenever a payment using a credit account number is going to be made during a payment data flow. Typically, when an AP file is received from a client with invoices to be paid, a merchant log can be created that contains the details of the payment to the vendor. Merchant logs can show, in an embodiment, vendor name, amount of transaction, as well as other client identified fields or data that is passed with each file.

Various methods could be used to create the merchant log, including, by way of example and not limitation: a) an accounts payable (AP) file, transferred using FTP (File Transfer Protocol) or uploaded via a web enabled user interface, b) manually entered through a web enabled user interface, or c) submitted to a solution service provider via a webservice. When the merchant log is created, a SUGA (single use ghost account) can be assigned in a step 210 from a pool of available accounts. In an embodiment, a SUGA can be an account number that can be defined a number of ways. For example, a SUGA can be a credit card number that does not have a corresponding physical “plastic” card. In an embodiment, it can also be a specific number provided to a preferred vendor for ongoing use, or an account number that is used when “pushing” a payment to a vendor without the vendor ever knowing the actual account number. Further, in an embodiment, a ghost account can be used for proprietary “push payment” technology to handle vendor payments that, in some cases, could number into the millions every month. In a step 215, a MCC (Merchant Category Code) number can be assigned to the merchant and that MCC can be used to create a MCCG (Merchant Category Code Group) name. The MCC and MCCG can be used to help organize and categorize various merchants. The merchant log's account can be updated with this MCC name and transactions can be restricted to this MCC.

In a step 220, the process to acquire funds can be determined. In an embodiment, this can be a wire transfer process. In another embodiment, this can be an automated clearinghouse (ACH) transaction. This also can be an automated step since the relationship between the organization/buyer and the financial institution already exists. In a step 225, an ACH file can be generated in an embodiment by the service provider based on information about the buyer contained within service provider's system to facilitate the transfer of funds from the organization/buyer to the financial institution. That ACH file then can be sent through the ACH system. In other embodiments, such transfer can be accomplished using a wire transfer or other similar payment mechanism. An ACH file can contain fields such as demand deposit account (DDA) numbers, routing numbers, and financial amount. The ACH file can be generated on a set frequency and can contain aggregated payments for all eligible merchant logs. Further, in a step 230 the ACH file can be transferred to the financial institution using SFTP (Secure File Transfer Protocol) immediately after it has been generated.

In a step 235, the ACH payment approval can be performed manually by the financial institution. In an embodiment, this approval process can be implemented using a web enabled application with administrative capabilities. The approver can be presented a list of pending ACH payments and can approve, cancel, or resubmit one or more payments. Approved payments can be allowed to continue through the process, while cancelling a payment can cause the process to terminate. A canceled payment can be resubmitted and can reopen the associated merchant log.

In a step 240, a payment facilitator can fund the transfer process. In an embodiment, after the ACH payment has been approved, appropriate files containing particular directions can be used to transfer funds from the financial institution to the payment facilitator via pushing a “credit” or payment on an account with a near zero balance, which results in a funded account. In an embodiment, this means the credit card now has a “credit balance” and is now in a “pre-funded” state. A determination can then be made in a step 245 of whether to transfer the payment facilitator funding file from the solution provider to the payment facilitator. This decision is automated after the financial institution acknowledges receipt of the funds from the organization/buyer. A payment facilitator funding file can be transferred in a step 250 to the payment facilitator using SFTP (Secure File Transfer Protocol) immediately after it's been generated.

In an embodiment, a payment facilitator funding file can be created on a set frequency. A payment facilitator funding file can contain information for the SUGA accounts associated with each merchant log. Using logic based on account's available balance to the merchant log amount, it can be determined or not the account was funded from the payment facilitator funding file. A monitor process can be put in place to provide notification when an account has not been funded after a configurable number of days.

In a step 255, a notification can be sent to the merchant. Such a notification can be sent in an embodiment via any appropriate means including, without limitation, via email, facsimilie, or both. When sending an email, an embedded link can be sent to the merchant in an embodiment directing the merchant to a website where the merchant can obtain the account number for payment. Further, in an embodiment, such an email can be sent in a manner that complies with the Payment Card Industry (PCI) Data Security Standard (DSS). For a fax transmission, the account number can be included on the fax the merchant receives so it can process payment. Merchants that use STP (Straight Through Processing, which enables the entire process for a payment transaction to be conducted electronically without the need for re-keying or manual intervention) will not receive a link or account information in their email or fax. Some merchants may use CSC (Card Security Code), which sometimes may be referred to as Card Verification Data (CVD), Card Verification Value (CVV or CVV2), Card Verification Value Code (CVVC), or Card Verification Code (CVC or CVC2). These are different terms for security features for credit or debit card transactions, providing increased protection against credit card fraud. In such cases, this number will not be displayed in the email, but can be viewable on the website page via the email provided and could also be included in a fax.

Upon being directed to a website to make a payment, a check can be performed in a step 260 as to whether the merchant will be subject to security checks. If so, such security checks can be performed in a step 265. Such security configuration can be set by the company (i.e., the buying organization), and may include a requirement on the merchant to use a specific PIN (Personal Identification Number) that must be known in order to have access to the billing details. The billing details page can be protected by a configurable amount of security (including, but not limited to, a variable number of sign-in attempts or by a number of outstanding days). If the merchant is not configured with a security requirement, the merchant can be allowed access directly to the billing information in a step 270. In an embodiment, the billing details can include a) the necessary amount to charge, b) the credit card number to use, c) card expiration number, and d) a CSC (if client uses it) and generally can include any other card specific information that would be needed by a merchant to submit a payment.

After merchant has access to the card information, the merchant can charge the account like any other credit card based payment in a step 272. After the merchant charges the card and the payment facilitator processes the payment in a step 274, the solution provider can receive the transaction from the payment facilitator via a file in a step 276.

In an embodiment, a merchant log auto reconciliation process can occur in a step 280. During this process, a solution provider can retrieve the merchant log eligible for reconciliation and match it with the transaction(s) associated with the same account. In an embodiment, the solution provider can use the threshold (e.g., the percentage of the transaction amount set up by the financial institution) configured for the organization/buyer. If the transaction falls into the defined threshold the merchant log can be considered reconciled. When a merchant log is reconciled, the account can be immediately closed by setting a derogatory account status (status that is set on the card processing system that prevents the card from being used).

In an embodiment, merchant logs can be marked as ‘Final Close’ by an administrator of the buyer (i.e., the entity named on and trying to pay its invoice) before it is considered complete. An administrative console (including, by way of example and not limitation, a web-enabled administrative console) can present a user from the buying organization with a list of closed, expired, and reconciled merchant logs that have yet to be marked as completed. In an embodiment, this administrative console can allow filtering and sorting to display the data and can allow multiple merchant log selections.

A check can be performed in a step 282 if a merchant log is marked as ‘Final Close’ and the associated account can be checked for unused funds on the account in a step 284. If so, then a Card Processor Funding File reversal can be performed for the amount of the unused funds in a step 286. An appropriate funding file can be created that will provide the buyer back all “unused” funds.

In a step 288, a number of reports can be created. In an embodiment, for example, a prefund reconciliation report can be created and provided to a financial institution to outline how much, if any, prefund dollars should be credited to each prefund organization/buyer for a given date range. Also, a statement report can be created for the organization/buyer and will display the funds that can be returned from the financial institution.

In a step 290, various configurations can be administered. These can include, for example, additional financial institution setting configurations in a web enabled solution that administrators can manage. Financial institution setting configuration could include but not be limited to:
indicating if financial institution participates in solution
specifying a place to store payment specific information (including, for example, financial institution routing transit number, financial institution account numbers, and any other field needed to process ACH)
specifying if the system requires the use of a CSC (Card Security Code)
specifying the number of days to delay the final close
determining whether the system requires a PIN (Personal Identification Code)
specifying the maximum number of merchant login attempts (this will limit the number of login attempts the merchant has when trying to view account info if a PIN is required)
indicating how to display name in the system (this setting will allow the program to be branded)
specifying the number of times the account information can be viewed before it is expired (the number of times the non-authenticated account view page is viewable)
specifying the number of days until account data view expires (the number of days the account view page can be viewed until it expires—this is for both the authenticated and non-authenticated pages).

Additional organization setting configurations can be included in a web enabled solution that administrators would manage. Organization settings would include, but not limited to: enabling the ‘Commercial Card Prefunding Through Automated ACH’ (Indicates an organization/buyer is using the solution), place to store ACH specific information (financial institution routing transit number, financial institution account numbers, ACH company ID, and any other field needed to process ACH, is a merchant PIN required (indicates if the merchant is required to have a PIN assigned—this could override the financial institution level setting configurations), text to display on various pages in the web based solutions.

Additional Merchant Setting Configurations can be included in a web enabled solution that administrators would manage. Merchant settings could include, for example: MCC (Merchant Category Code) of the merchant and the PIN required for the merchant.

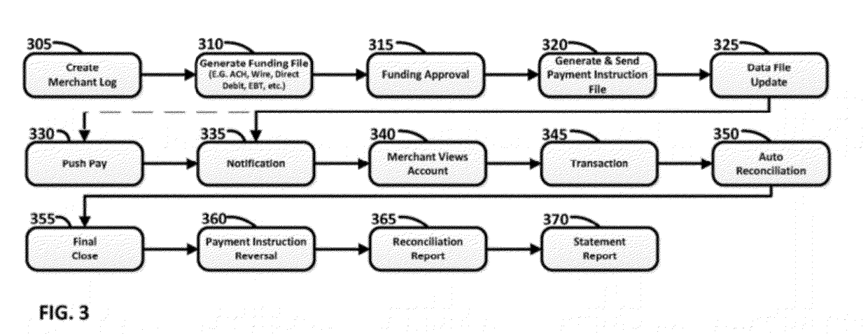

According to another embodiment of the current invention, a system for automated prefunding could be implemented as detailed with respect to FIG. 3. In the prefund flow shown in FIG. 3, certain accounts payable (AP) functionality can allow accounts to be prefunded via an ACH transfer of funds from an organization/buyer (or client) to a financial institution and eventually to a payment facilitator, such as a payment facilitator, check processor, or ACH processor. This functionality can be used for higher credit risk organizations instead of the traditional credit limit funding method.

From a data flow perspective, prefund methodology can bypass the credit limit update process and can allow a series of processes to be implemented for moving funds from the organization/buyer, allowing financial institution approval, funding the account at an electronic payment systems processor, and finally resolving funding differences between the original merchant log and transaction(s) using reversals.

A notification process can be implemented for the prefunds process because, unlike the credit limit methodology, the merchant is provided a new account for every merchant log. To satisfy PCI requirements, a temporary link can be sent to the merchant in an email (a fax will contain the full account number) where they can view the account number via an appropriate website.

An exemplary high level prefund flow from merchant log creation to the final reporting stage is shown in FIG. 3. In a step 305 shown in FIG. 3, merchant logs can be created using one of three methods:

Accounts Payable (AP) File—A file containing invoices for one or more merchants can be delivered to a service provider using FTP or uploaded via a service provider website.

AP Online—Individual merchant logs can be manually entered on the website and proceed through workflow where approval is obtained.

AP Webservice—Merchant log information can be submitted using a webservice, thereby causing a merchant log to be created.

In an embodiment of the present invention, when a merchant log is created, a SUGA (single use ghost account) can be assigned to a merchant log from a pool of available accounts, where the available accounts are account numbers that have been reserved by the service provider for use with prefunding. Further, a merchant can be assigned a unique code and that code can then be grouped with codes from other merchants (e.g., based on the merchant's industry). In an embodiment, a Merchant Category Code (MCC) number can be assigned to a merchant and can be assigned to a payment facilitator MCC group name. The merchant log's account can be updated with this MCC name and transactions can be restricted to this MCC.

In a step 310, an ACH file can be generated to facilitate the transfer of funds from the organization/buyer to the financial institution. In an embodiment, the ACH file will be generated one time daily and may contain aggregated payments for all eligible merchant logs. The payments within the ACH file can be aggregated by organization, source file, and merchant log source type (file, AP online, or webservice). This means an ACH file may contain one or more payments for multiple organizations and the total dollar amount of an organization/buyer's payment will represent the sum of invoice dollar amounts from the source it originated. Once generated, the ACH file can be transferred to the financial institution using the Secure File Transfer Protocol (SFTP) immediately after it's been generated. In an embodiment, no ACH confirmation message or file needs to be sent back from the financial institution.

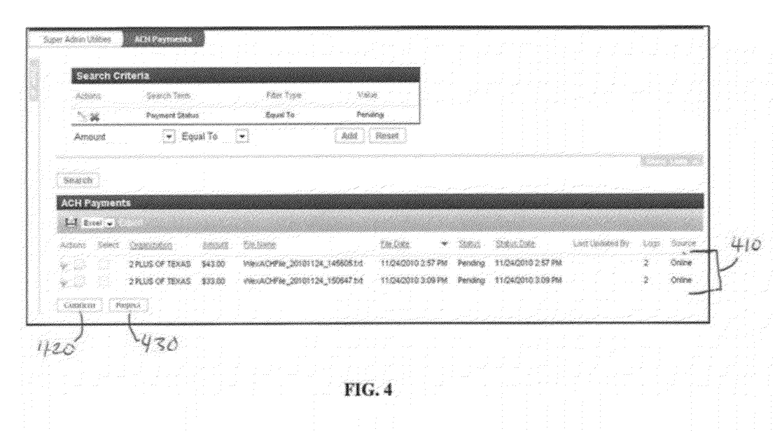

In a step 315, the funding approval can be performed manually using an administrative website page displayed by the service provider, such as the screen shown in FIG. 4. The user from the financial institution can be presented with a list 410 of pending ACH payments at the organization/file/source level and will be able to approve, cancel, or resubmit one or more payments. In an embodiment, the administrative website page shown in FIG. 4 can also be used for:
Approving a pending payment via a Confirm button 420, which can mark the associated merchant logs as approved and they can proceed through the process flow.
Rejecting a pending payment via a Reject button 430, which will mark the associated merchant logs as closed and they will not continue through the process flow.
Resubmitting a cancelled payment, which will reopen the associated merchant logs and will be eligible for the next ACH file generation.

Also in an embodiment, the administrative website page can provide filtering and sorting to allow convenient viewing of the data. There can be a link for each organization/buyer's payment that will redirect the financial institution user to the merchant log search results page and display all merchant logs associated with the payment. This can allow the financial institution user to determine the purpose for the funds and what mechantlogs make up the amount being requested. Filtering can allow display of payments by date and approved or cancelled payments.

After an ACH payment has been approved, the merchant logs associated with the payment in an embodiment of the present invention can become eligible for inclusion in a payment instruction file in a step 320. A payment instruction file is a particular format used in one embodiment of the present invention that corresponds to a particular payment processor known as payment facilitator. The payment instruction file can be used to transfer funds from the financial institution to payment facilitator, which can result in a funded account. The payment instruction file can be generated one time daily or at any other reasonable frequency. The payment instruction file can further be transferred to payment facilitator using SFTP immediately after it has been generated. No confirmation message or file is expected back from payment facilitator.

In a step 325, a daily data file can contain information for the SUGA accounts associated with each merchant log. By comparing the account's available balance to the merchant log amount, a service provider can determine whether or not the account has been funded from the payment instruction file. If the account has been funded, the merchant log can be released to the next step in the processing. If the account has not been funded, the merchant log can remain dormant until the next data file processing day. In an embodiment, a monitor process can also be implemented to provide notification when an account has not been funded after a configurable number of days. This notification will alert the service provider that funds have not been received for the particular SUGA accounts and, correspondingly, that merchants have not been paid.

In an embodiment, merchant logs associated with PushPay merchants (i.e., merchants that receive payment automatically as a result of the funds being pushed or otherwise deposited directly into their account) can be optionally submitted for merchant payment in a step 330. For non-PushPay merchants, a notification can be sent to the merchant in a step 335 via email, fax, or both. A remit template maintenance website page can be used in an embodiment to maintain templates for the organization/buyer or the merchant.

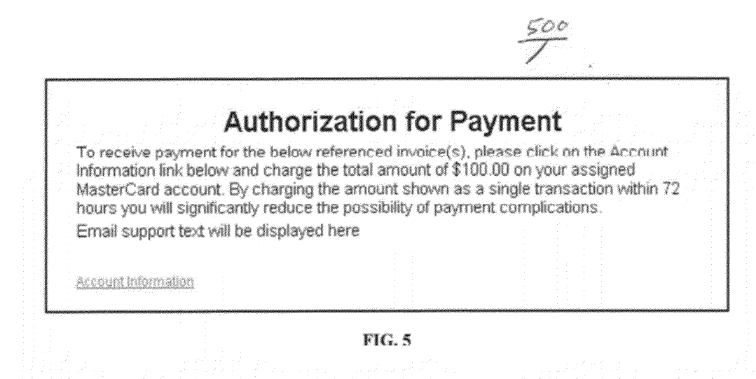

In an email, a link could be sent to the merchant that can direct them to a website page 500 shown in FIG. 5 where they would be able to access and view the account information as shown in a step 340. No account number needs to be included in the email. The full account number, however, can be included on a fax. For financial institutions using CSC (card security code), this number will not be displayed in the email, but will be viewable on the website page via the email link and will be included on a fax. In an embodiment utilizing PushPay, merchants may not receive a link or account information in their email/fax. In an embodiment using PullPay (i.e., a system where a solutions provider can deliver a complete set of payment information to the merchant thereby allowing the merchant to process the payment accordingly or otherwise pull the payment into their account), an email to a merchant email will contain an embedded link which will direct the merchant to a temporary page displaying the full account number.

Further in a step 340, a merchant configured with a PIN can be required to sign in using the PIN (or any other appropriate log in information) in order to gain access to the account information page. The merchant can then, in an embodiment, be permitted to view this page for a configurable number of days before it expires. The merchant could also have a maximum number of tries to sign in (with that maximum number of tries being configurable) and will be locked out if the the maximum number of allowable attemptsis exceeded. Failing to authenticate can result in a generic “You are not authorized to view this page” error message. If the merchant has not been configured with a PIN, the sign in page can be bypassed and the account info page can be made to be viewable only one time. After the one view, the page can be expired.

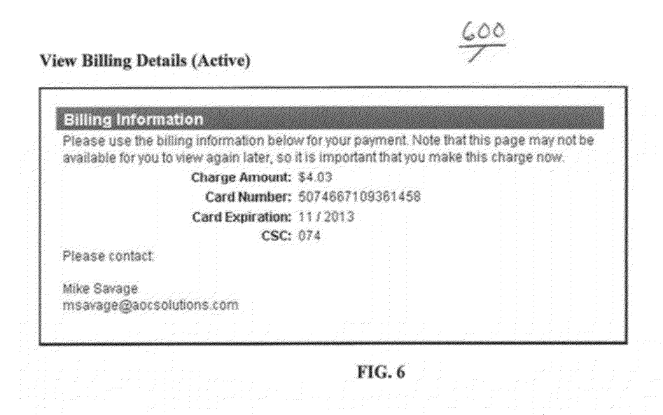

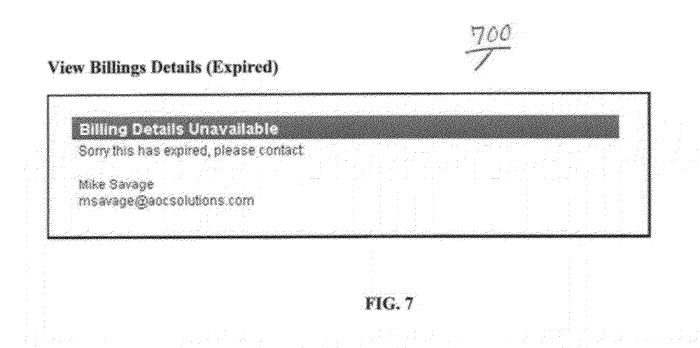

Once logged in, the merchant can access a page 600 shown in FIG. 6 that displays the account information. The decision about what information can be displayed on this page, (including, by way of example and not limitation, whether the CSC will be displayed or whether customized text will be used), can be made configurable for the buyer. After the page expires or the merchant has exceeded the maximum number of sign in attempts, an email link can direct the merchant to an expiration page 700 shown in FIG. 7 that contains organization/buyer specific text, which could contain contact info and instructional text.

In a step 345, the merchant can run the transaction using an account that has been prefunded. In an embodiment, the merchant may run the transaction using card data associated with a card that has been funded using the payment instruction process. That card data can be used to run the transaction on a local point of sale (POS) terminal.

After a predetermined period of time, the merchant can charge the card. Once such a charge is made, the service provider can receive a corresponding transaction from payment facilitator in the data file file. In a step 350, a merchant log auto reconciliation process can retrieve the merchant log eligible for reconciliation and match it with the transaction(s) associated with the same account. The auto reconciliation process can use a threshold if one is configured for the organization/buyer. Such a threshold could be, in an embodiment, specified by the organization/buyer and could be a fixed amount over the threshold or a percentage above or below the threshold. In another embodiment, such a threshold could be specified by the financial institution. If the transaction amount falls into this threshold the merchant log will be considered reconciled otherwise it will be matched (partially reconciled). When a merchant log is reconciled, the account will be immediately closed by setting a derogatory account status.

In a step 355, a merchant log can be marked in an embodiment as Final Close by an administrator for the buyer before it is considered complete. A new administrator website page can present the user representing the buyer with a list of closed, expired, and reconciled merchant logs that have yet to be marked as completed. In an embodiment, this page can take into consideration the number of days to delay Final Close when displaying merchant logs (this delay is needed because the service provider has no way to differentiate between a $0 funded account where funds have been reversed vs. one where a transaction was done). This page can also allow filtering and sorting for convenient data display and can allow multiple merchant log selection.

Merchant logs marked as Final Close may still have unused funds on the account. In a step 360, the payment instruction reversal process can retrieve merchant logs with unused funds and create a payment instruction reversal. This can initiate the transfer of funds from payment facilitator back to the financial institution, which can be used to remove a credit that may have been put on an account at the payment facilitator. A separate process can confirm the funds have been reversed on the account and this will be noted on the account.

A prefund reconciliation report shown in a step 365 can be used to provide the financial institution with a way to determine how much, if any, prefund dollars should be credited to each prefund organization/buyer for a given date range. This can provide the financial institution with a way to determine the amount of prefund dollars to be credited to each prefund organization/buyer. This could be implemented in a report management tool (such as a report focus in Report Studio that is a part of the EnCompass product) that would provide a summary view by organization/buyer with drill-down capability to see individual merchant log level details. In one embodiment, the primaryfilter for this report could be a range of final close dates. This could support a periodic process by which the financial institutions could manage crediting unused prefund dollars. For example, the financial institution could decide to credit organization/buyers on the 5th day of each month for all merchant logs final-closed in the preceding month.

In an embodiment, this report could display the following at the summary level:

Prefund Reconciliation Report
Final Close Date Aug. 01, 2010 to Aug. 31, 2010

| | Company | Log | | Trans | | Prefund |
|---|---|---|---|---|---|---|
| Organization | No | Count | Log Total | Count | Trans Total | Credit |
| Crazy Horse Cigar | 601234 | 27 | $356,201.55 | 32 | $355,702.21 | $499.34 |
| Store | | | | | | |
| Supersaver | 602392 | 5 | $55,251.86 | 5 | $55,251.86 | $0.00 |
| Gasoline | | | | | | |
| Wonderful | 619384 | 129 | $4,126,789.88 | 127 | $4,100,234.78 | $26,555.10 |
| Widgets Inc. | | | | | | |
| Total | | 161 | $4,538,243.29 | 164 | $4,511,188.85 | $27,054.44 |

The existing Merchant Log/Ap Recon reports could allow filtering on final close date for prefund organizations/buyers providing a detailed view of both merchant logs and transactions. In a step 370, a statement report can be oriented to the organization/buyer and can display the funds that will be returned from the financial institution

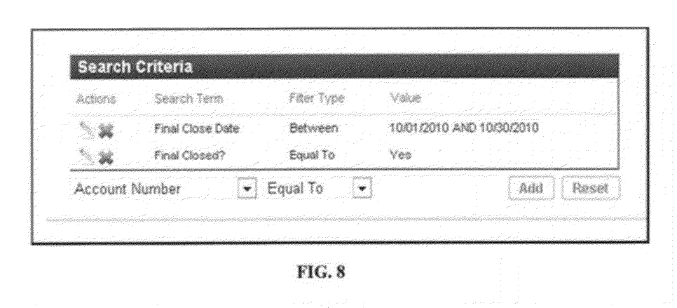

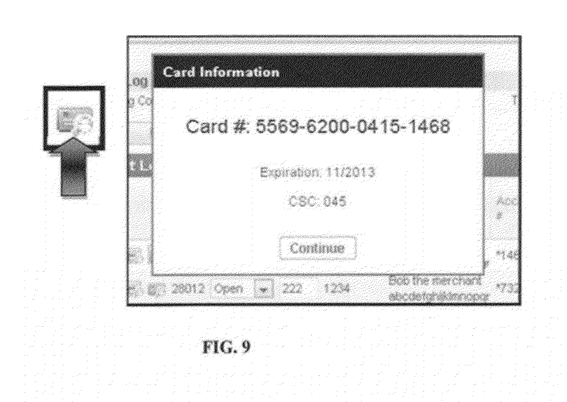

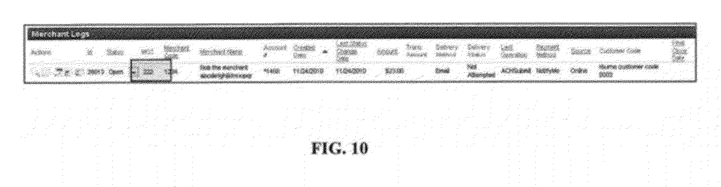

In an embodiment, various other functions can be implemented:
As shown in FIG. 8, for example, filters can be added to the merchant log search page, which will allow searching by any prefunded payment types.
An icon can be added to allow viewing the merchant log's full account info, as depicted in FIG. 9. Viewing the account info will be configurable by merchant log status (open, closed, etc.).
FIG. 10 depicts another embodiment in which an icon can be added to allow the MCC number to be manually set. This can then override the MCC number set from the merchant during merchant log creation. This can only be done for open merchant logs. This can permit transactions coded with the incorrect MCC to be propely paid, by allowing the incorrect MCC to be corrected.
When a merchant log is closed or reconciled, the account will immediately be changed to a derogatory account status to stop further auths/charges on the account.
When a merchant log is reopened, the account will be taken out of the derogatory account status. There can be an instance where an account is no longer available so setting the account status will fail. In this case, an error message will be displayed to the user.

One additional features for prefunds merchant logs involves immediately changing an account to a derogatory account statue when a merchant log is expired in order to stop further authorizations or charges on the account.

The following features of the Merchant Upload Process can be made available in an embodiment of the present invention:
Allowing an MCC number to be included on the merchant upload record
Allowing a Merchant PIN to be included on the merchant upload record
Forcing the upload process to observe the same validation rules as the merchant maintenance page with respect to these fields

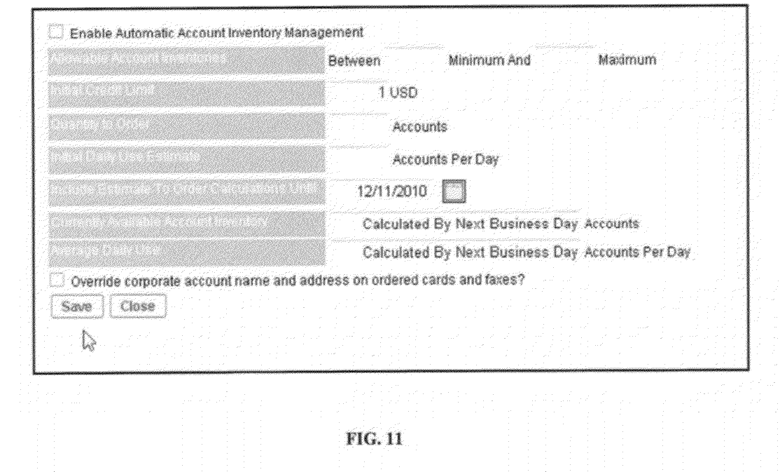

In an embodiment, financial institutions can manually manage the pool of accounts available for each prefunds organization/buyer using the functions depicted in FIG. 11. It can be the financial institution's responsibility to monitor account availability on a daily basis and to order enough cards to prevent organization/buyers from running out. Note that lack of available cards can prevent merchant logs from being created, regardless of the source (Invoice File, AP On-Line, or AP Web Services).

The following financial institution settings can be utilized to support prefunds. These settings will not be configurable from the website:
Allow prefund organization/buyers—can be used to enable or disable configuring organization/buyers as prefund
ACH info—can include routing transit number, financial institution account number, etc.
Display CSC—can be used to specify if CSC is included in the notification fax or on the page merchant will view account info
Number of days to delay Final Close—defines the number of days to disallow closed, expired, or reconciled merchant logs that will have a payment instruction reversal to be Final Closed.
Require PIN—specifies if, by default, a PIN is required to view account info. This value may be overridden at the organization level.
Maximum number of merchant login attempts—limits the number of login attempts the merchant has when trying to view account info if a PIN is required.
Prefunds display name—allows the prefund program to be branded, e.g., PrePay, etc.
Number of account views until expiration—specifies the number of times the non-authenticated account view page is viewable. This will default to 1 view.
Days until account view expires—specifies the number of days the account view page can be viewed until it expires. This is for both the authenticated and non-authenticated pages. This will default to 7 days.
Plog rotating account code—specifies the code used to retrieve and order plog rotating accounts.
AP rotating account code—specifies the code used to retrieve and order AP rotating accounts.

The following organization/buyer settings can be configurable on the organization/buyer maintenance page:
Prefunds enabled—Indicates an org is prefunds or not. An org will not be able to transition from prefunds to non-prefunds and vice versa.
ACH info—Financial institution routing number, ACH company name, ACH company ID, etc.
Merchant PIN required—Indicates if the merchant is required to have a PIN assigned. This overrides the financial institution level setting.
Non-expired account view page display text—This text will be displayed on the non-expired account view page. Typically this will be used to display org contact info.
Expired account view page display text—This text will be displayed on the expired account view page. Typically this will be used to display org contact info.
The following merchant settings will be configurable on the merchant maintenance page:
MCC number—This MCC number will be converted into the most restrictive payment facilitator MCC group configured for the financial institution.
Merchant PIN—The PIN required for the merchant to display the account view page. If this field is not populated, the merchant will only be able to display the account view page one time. This is required based on the org level setting Merchant PIN Required.
Changes to the merchant maintenance page:
For merchants associated with a prefund org, the account number field will be disabled.

Those of skill in the art would understand that information and data may be represented using any of a variety of different technologies and techniques. For example, data, instructions, commands, information, signals, bits, and symbols, that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the-scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method for a service provider to prefund user accounts, implemented at least in part by a computing device, said method comprising:
receiving an invoice naming an organization;
generating one or more payment instructions based on the invoice;
causing funds to be transferred from the organization to a funding entity;
receiving approval of a payment;
creating a funded account by transferring payment directions that cause funds to be transferred from the funding entity to a payment facilitator;
transmitting a notification to one or more sellers;
receiving log in information from the one or more sellers to authenticate the one or more sellers; and
processing account charge instructions received from the one or more sellers that cause funds to be transferred from the payment facilitator to the one or more sellers.

2. A method as in claim 1, wherein the payment instructions are contained in an ACH file.

3. A method as in claim 2, wherein the ACH file is created according to a predetermined frequency.

4. A method as in claim 2, wherein the ACH file further comprises aggregated payments.

5. A method as in claim 2, wherein the ACH file is securely transferred.

6. A method as in claim 5, further comprising the use of the SFTP protocol.

7. A method as in claim 1, wherein the funding entity further comprises a financial institution.

8. A method as in claim 1, wherein the payment directions further comprise a file specifying one or more payment mechanisms.

9. A method as in claim 8, further comprising a payment facilitator funding file containing information for one or more single user ghost accounts.

10. A method as in claim 1, wherein the payment facilitator further comprises one or more of a credit payment facilitator, a wire processor, a check processor, or an ACH processor.

11. A method as in claim 1, wherein the notification to one or more sellers comprises an electronic mail message, a facsimilie transmission, or both.

12. A method as in claim 11, wherein the email message and facsimilie message are generated in a manner that complies with one or more security standards.

13. A method as in claim 12, wherein the one or more security standards includes the PCI Data Security Standard.

14. A method as in claim 1, wherein the log in information comprises a PIN.

15. A method as in claim 1, further comprising a reconciliation of a merchant log with one or more transactions contained in the account charge instructions.

16. A method as in claim 15, further comprising:
retrieving the merchant log corresponding to the authenticated seller;
matching one or more transactions associated with an account of the seller; and
closing the account when all transactions have been reconciled with the merchant log.

17. A method as in claim 16, further comprising:
checking the one or more transactions against a threshold that has been configured for the buyer; and
reconciling the transaction with the merchant log.

18. A method for a financial institution to prefund user accounts, implemented at least in part by a computing device, said method comprising:
receiving an invoice naming a buyer;
generating one or more payment instructions based on the invoice;
receiving funds from the buyer;
receiving approval of the payment;
creating a funded account by transferring funds from the financial institution to a payment facilitator;
transmitting a notification to one or more sellers;
receiving log in information from the one or more sellers to authenticate the one or more sellers; and
processing account charge instructions received from the one or more sellers.

19. A method for a payment facilitator to prefund user accounts, implemented at least in part by a computing device, said method comprising:
receiving an invoice and funds from a buyer;
creating a funded account;
receiving approval of a payment to a seller;
transmitting a notification to one or more sellers;
receiving log in information from the one or more sellers to authenticate the one or more sellers; and
processing account charge instructions received from the one or more sellers.
